(19) United States
(12) Patent Application Publication
(10) Pub. No.: US 2026/0150014 A1
(43) Pub. Date: May 28, 2026

(54) HANDOVER FAILURE RECOVERY BASED ON NETWORK INDICATION

(71) Applicant: LG ELECTRONICS INC., Seoul (KR)

(72) Inventors: Siyoung CHOI, Seoul (KR); Sunghoon JUNG, Seoul (KR)

(73) Assignee: LG ELECTRONICS INC., Seoul (KR)

(21) Appl. No.: 19/123,321

(22) PCT Filed: Oct. 25, 2023
(86) PCT No.: PCT/KR2023/016604

§ 371 Date: Apr. 22, 2025

Related U.S. Application Data
(60) Provisional application No. 63/421,587, filed on Nov. 2, 2022.

(51) Int. Cl. H04W 36/00; H04W 36/32

(52) U.S. Cl. CPC H04W 36/0061; H04W 36/324

(57) ABSTRACT

A method and apparatus for handover failure recovery based on network indication is provided. A wireless device receives one or more candidate cell configurations for one or more candidate cells. The one or more candidate cells include one or more primary candidate cells and one or more secondary candidate cells. The wireless device receives a cell switch command triggering mobility to a primary candidate cell from among the one or more primary candidate cells, and executes a mobility to the primary candidate cell. The wireless device evaluates a failure of the mobility, and upon detecting the failure of the mobility, executes a mobility to a secondary candidate cell from among the one or more secondary candidate cells.

### CROSS-REFERENCE TO RELATED APPLICATIONS

This application is the National Stage filing under 35 U.S.C. 371 of International Application No. PCT/KR2023/016604, filed on Oct. 25, 2023, which claims the benefit of U.S. Provisional Application No. 63/421,587 filed on Nov. 2, 2022, the contents of which are all hereby incorporated by reference herein in their entireties.

### TECHNICAL FIELD

The present disclosure relates to handover failure recovery based on network indication.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

When a User Equipment (UE) moves from the coverage area of one cell to another cell, at some point, a serving cell change needs to be performed. Currently, serving cell change is triggered by L3 measurements and is done by Radio Resource Control (RRC) signaling-triggered Reconfiguration with Synchronization for change of Primary Cell (PCell) and Primary Secondary Cell (PSCell), as well as release add for SCells when applicable. All cases involve complete L2 (and L1) resets, leading to longer latency, larger overhead and longer interruption time than beam switch mobility.

The goal of L1/L2 mobility enhancements is to enable a serving cell change via L1/L2 signaling, in order to reduce the latency, overhead and interruption time.

### SUMMARY

The present disclosure is to provide a method and apparatus for performing a recovery procedure for Lower-layer Triggered Mobility (LTM) failure based on a network indication.

In an aspect, a method performed by a wireless device adapted to operate is provided. The method comprises receiving one or more candidate cell configurations for one or more candidate cells. The one or more candidate cells include one or more primary candidate cells and one or more secondary candidate cells. The method comprises receiving a cell switch command triggering mobility to a primary candidate cell from among the one or more primary candidate cells, and executing a mobility to the primary candidate cell. The method comprises evaluating a failure of the mobility, and upon detecting the failure of the mobility, executing a mobility to a secondary candidate cell from among the one or more secondary candidate cells.

In another aspect, an apparatus for implementing the above method is provided.

The present disclosure may have various advantageous effects.

For example, a UE can attempt to access a secondary candidate cell upon detecting a failure of LTM to a primary candidate cell.

For example, user data interruption can be reduced by performing faster recovery than conventional failure recovery based on an RRC reestablishment procedure.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of a method performed by a wireless device to which implementations of the present disclosure are applied.

FIG. 9 shows an example of a method performed by a base station to which implementations of the present disclosure are applied.

FIG. 10 shows an example of a procedure to which Implementation 1 of the present disclosure is applied.

FIG. 11 shows an example of a procedure to which Implementation 2 of the present disclosure is applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

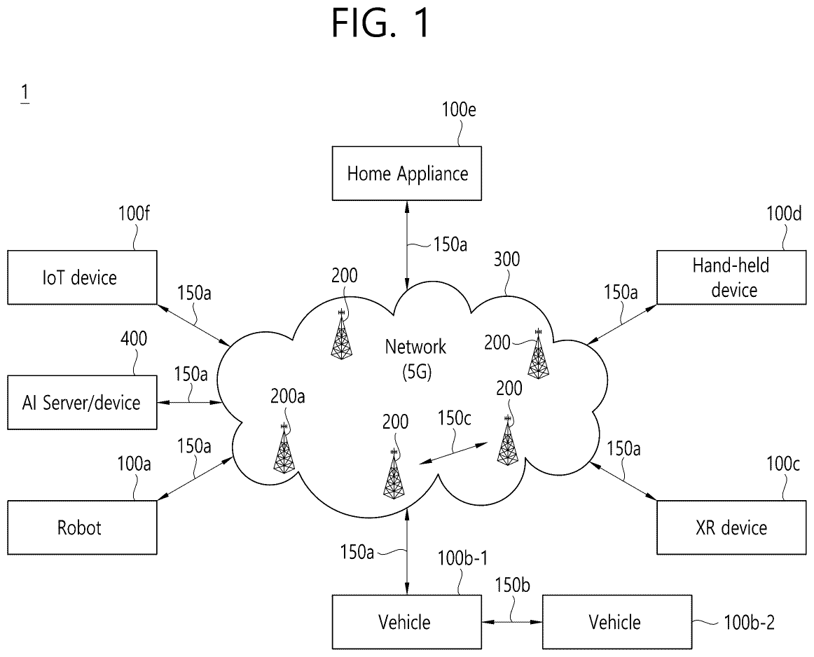

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

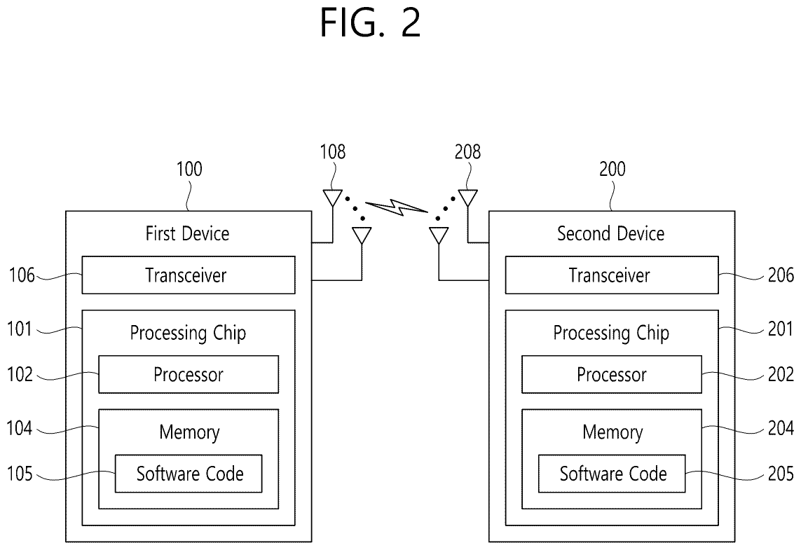

FIG. 2 shows an example of wireless devices to which implementations of the present disclosure are applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

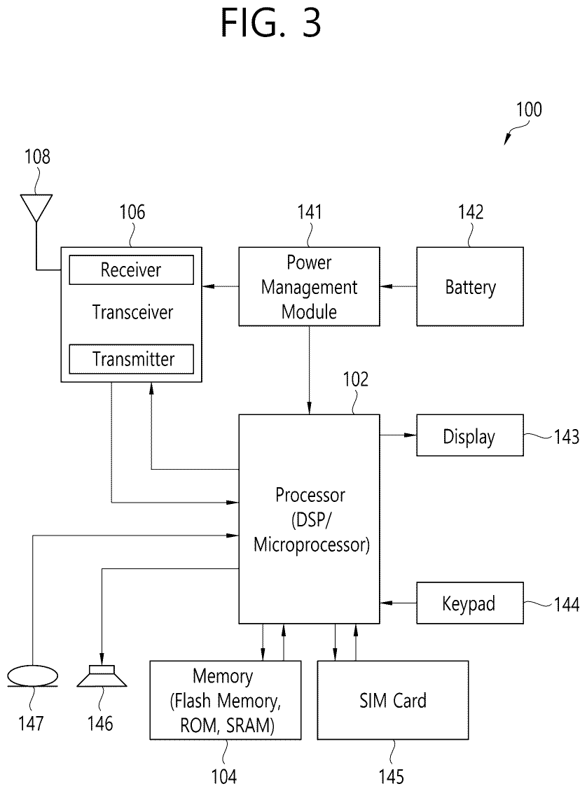

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

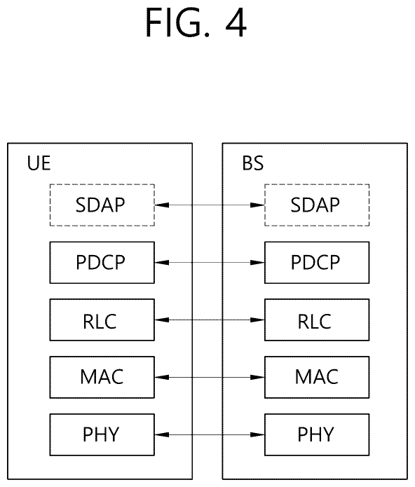

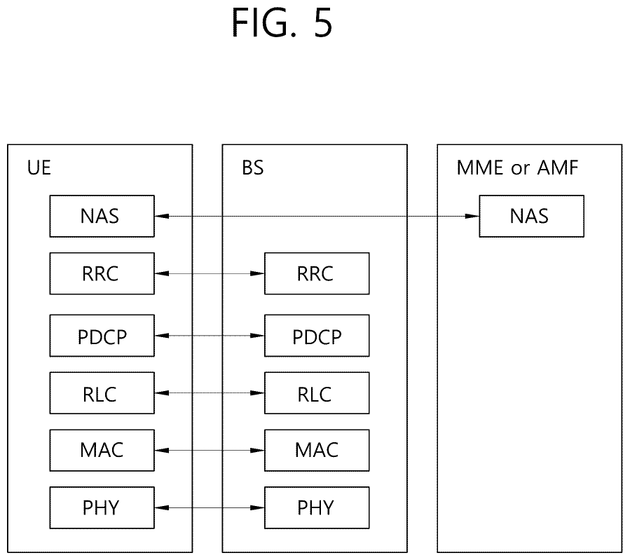

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

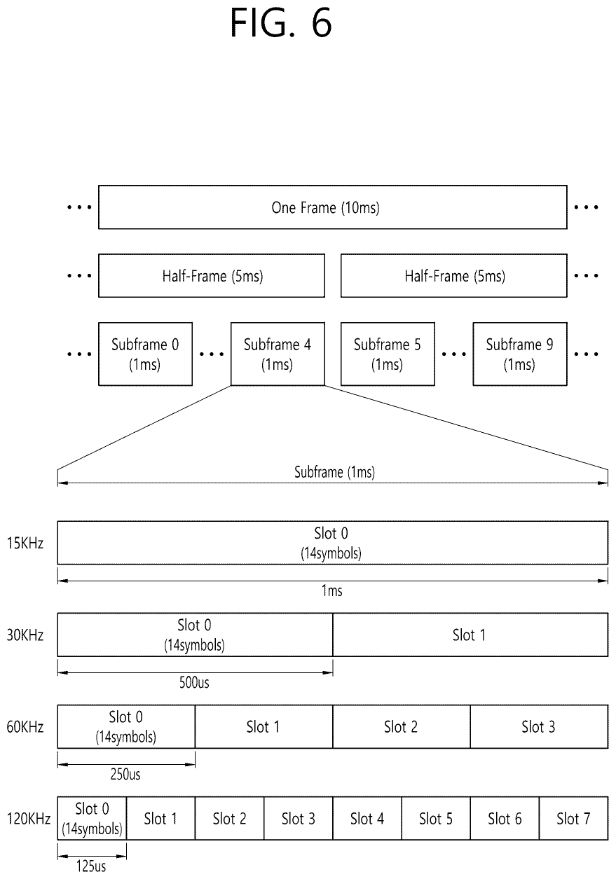

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

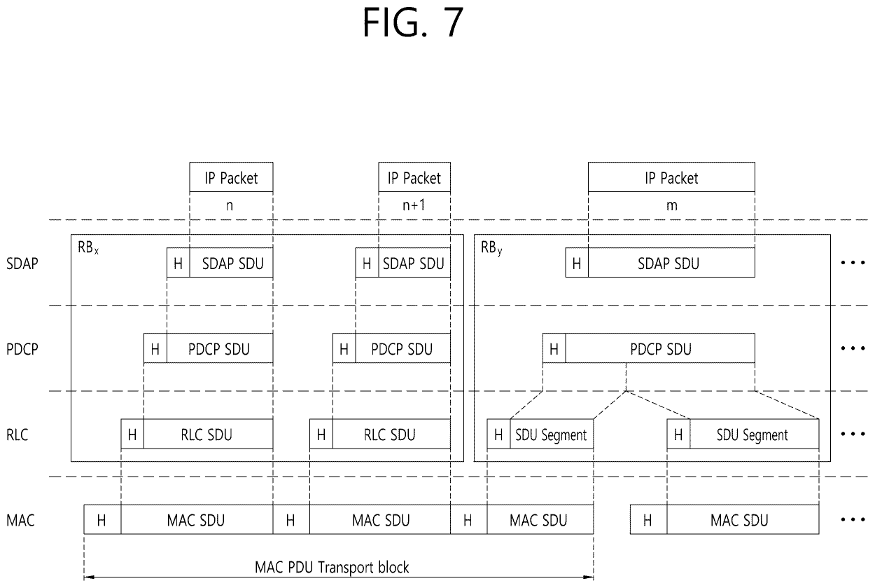

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Network controlled mobility applies to UEs in RRC_CONNECTED and is categorized into two types of mobility: cell level mobility and beam level mobility. Beam level mobility includes intra-cell beam level mobility and inter-cell beam level mobility.

Cell level mobility requires explicit RRC signaling to be triggered, i.e., handover. For inter-gNB handover, the signaling procedures consist of at least the following operations.
1. The source gNB initiates handover and issues a HANDOVER REQUEST message over the Xn interface.
2. The target gNB performs admission control and provides the new RRC configuration as part of the HANDOVER REQUEST ACKNOWLEDGE message.
3. The source gNB provides the RRC configuration to the UE by forwarding the RRCReconfiguration message received in the HANDOVER REQUEST ACKNOWLEDGE message. The RRCReconfiguration message includes at least cell identity (ID) and all information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete message.

In case of Dual Active Protocol Stack (DAPS) handover, the UE continues the DL user data reception from the source gNB until releasing the source cell and continues the UL user data transmission to the source gNB until successful random access procedure to the target gNB.

Only source and target PCell are used during DAPS handover. CA, DC, Supplementary UL (SUL), multi-Transmission/Reception Point (TRP), Ethernet Header Compression (EHC), Conditional Handover (CHO), User Data Convergence (UDC), NR sidelink configurations and V2X sidelink configurations are released by the source gNB before the handover command is sent to the UE and are not configured by the target gNB until the DAPS handover has completed (i.e., at earliest in the same message that releases the source PCell).

The handover mechanism triggered by RRC requires the UE at least to reset the MAC entity and re-establish RLC, except for DAPS handover, where upon reception of the handover command, the UE:
Creates a MAC entity for target;
Establishes the RLC entity and an associated DTCH logical channel for target for each DRB configured with DAPS;
For each DRB configured with DAPS, reconfigures the PDCP entity with separate security and ROHC functions for source and target and associates them with the RLC entities configured by source and target respectively;
Retains the rest of the source configurations until release of the source.

RRC managed handovers with and without PDCP entity re-establishment are both supported. For DRBs using RLC AM mode, PDCP can either be re-established together with a security key change or initiate a data recovery procedure without a key change. For DRBs using RLC UM mode, PDCP can either be re-established together with a security key change or remain as it is without a key change. For SRBs, PDCP can either remain as it is, discard its stored PDCP PDUs/SDUs without a key change or be re-established together with a security key change.

Data forwarding, in-sequence delivery and duplication avoidance at handover can be guaranteed when the target gNB uses the same DRB configuration as the source gNB.

Timer based handover failure procedure is supported in NR. RRC connection re-establishment procedure is used for recovering from handover failure except in certain CHO or DAPS handover scenarios:
When DAPS handover fails, the UE falls back to the source cell configuration, resumes the connection with the source cell, and reports DAPS handover failure via the source without triggering RRC connection re-establishment if the source link has not been released.
When initial CHO execution attempt fails or HO fails, the UE performs cell selection, and if the selected cell is a CHO candidate and if network configured the UE to try CHO after handover/CHO failure, then the UE attempts CHO execution once, otherwise re-establishment is performed.

Beam level mobility does not require explicit RRC signaling to be triggered. Beam level mobility can be within a cell, or between cells, the latter is referred to as Inter-Cell Beam Management (ICBM). For ICBM, a UE can receive or transmit UE dedicated channels/signals via a TRP associated with a Physical Cell ID (PCI) different from the PCI of a serving cell, while non-UE-dedicated channels/signals can only be received via a TRP associated with a PCI of the serving cell. The gNB provides via RRC signaling the UE with measurement configuration containing configurations of Synchronization Signal Block (SSB)/Channel State Information (CSI) resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signaling, and RRC is not required to know which beam is being used at a given point in time.

SSB-based beam level mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.

CHO is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only single Reference Signal (RS) type is supported and at most two different trigger quantities (e.g., Reference Signal Received Power (RSRP) and Reference Signal Received Quality (RSRQ), RSRP and Signal-to-Noise plus Interference Ratio (SINR), etc.) can be configured simultaneously for the evaluation of CHO execution condition of a single candidate cell.
Before any CHO execution condition is satisfied, upon reception of HO command (without CHO configuration), the UE executes the HO procedure, regardless of any previously received CHO configuration.
While executing CHO, i.e., from the time when the UE starts synchronization with target cell, the UE does not monitor source cell.

In Rel-18, L1L2-Triggered Mobility (LTM) is introduced in order to reduce latency, overhead and interruption time. For LTM, the network may provide the UE in advance with the configuration of a candidate serving cell, i.e., pre-configuration of candidate cells for LTM. After receiving the pre-configuration of candidate cells for LTM, if the UE receives the corresponding cell switch command via L1/L2 signaling (i.e., LTM command) from the network, the UE applies the configuration of the candidate serving cell indicated by L1/L2 signaling. The UE may only execute LTM by indication from the network. That is, the UE may not execute LTM by itself without network indication.

An example of the UE operations for the LTM may be as follows.

The network may configure the UE with one or more LTM candidate configurations within the LTM-Config IE.

LTM candidate configuration is a configuration associated with an LTM candidate cell. An LTM candidate configuration may be a complete LTM candidate configuration or a delta (difference) configuration with respect to an LTM reference configuration.

LTM reference configuration is a configuration provided by the network to the UE that is common, within the same cell group, to all the configured non-complete LTM candidate configurations. It is used by the UE to generate a complete LTM candidate configuration by applying an LTM candidate configuration on top of an LTM reference configuration.

Table 5 shows an example of LTM-Config. The Information Element (IE) LTM-Config is used to provide LTM candidate cell configuration, i.e., the pre-configuration of candidate cells for LTM.

TABLE 5
-- ASN1START
-- TAG-LTM-CONFIG-START
LTM-Config-r18 ::= SEQUENCE {

| | |
|---|---|
| ltm-ReferenceConfiguration-r18 | OCTET STRING (CONTAINING |
| RRCReconfiguration) | OPTIONAL, -- Need M |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-ServingCellNoResetID-r18 | INTEGER (1.. maxNrofCellsLTM- |
| r18-plus-1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-

| | |
|---|---|
| ResourceConfig-r18 | OPTIONAL, -- Need N |
| ltm-CSI-ResourceConfigToReleaseList-r18 | SEQUENCE (SIZE |

(1..maxNrofLTM-CSI-ResourceConfigurations-r18)) OF LTM-CSI-

| | |
|---|---|
| ResourceConfigId-r18 | OPTIONAL, -- Need N |
| attemptLTM-Switch-r18 | ENUMERATED {true} |

OPTIONAL, -- Need LTM-MCG

| | |
|---|---|
| ltm-ServingCellUE-MeasuredTA-ID-r18 | INTEGER (1.. |
| maxNrofCellsLTM-r18-plus-1) | OPTIONAL, -- Cond LTM |

...
}
LTM-CandidateToReleaseList-r18 ::= SEQUENCE (SIZE (1..maxNrofCellsLTM-
r18)) OF LTM-CandidateId-r18
-- TAG-LTM-CONFIG-STOP
-- ASN1STOP

According to Table 5, a reference configuration (i.e., ltm-ReferenceConfiguration) may be configured. A UE may store the reference configuration as a separate configuration. The reference configuration may be managed separately.

Table 6 shows an example of LTM-CandidateToAddModList, which may be included in LTM-Config shown in Table 5. The IE LTM-CandidateToAddModList concerns a list of LTM candidate cell configurations to add or modify.

TABLE 6
-- ASN1START
-- TAG-LTM-CANDIDATETOADDMODLIST-START
LTM-CandidateToAddModList-r18 ::= SEQUENCE (SIZE (1..maxNrofCellsLTM-
r18)) OF LTM-Candidate-r18
LTM-Candidate-r18 ::= SEQUENCE {

| | |
|---|---|
| ltm-CandidateId-r18 | LTM-CandidateId-r18, |
| ltm-CandidatePCI-r18 | PhysCellId, |
| ltm-SSB-Config-r18, | LTM-SSB-Config-r18 |

OPTIONAL, -- Need M

| | |
|---|---|
| ltm-CandidateConfig-r18 | OCTET STRING |
| (CONTAINING RRCReconfiguration), | OPTIONAL, -- Need M |
| ltm-ConfigComplete-r18 | ENUMERATED {true} |

OPTIONAL, -- Need R

| | |
|---|---|
| ltm-EarlyUL-SyncConfig-r18 | SetupRelease |
| { EarlyUL-SyncConfig-r18 } | OPTIONAL, -- Need M |
| ltm-NoResetID-r18 | INTEGER |
| (1..maxNrofCellsLTM-r18-1) | OPTIONAL, -- Need M |
| ltm-DL-OrJointTCI-StateToAddModList-r18 | SEQUENCE (SIZE |

(1..maxNrofCandidateTCI-States-r18)) OF CandidateTCI-State-r18
OPTIONAL, -- Need N

| | |
|---|---|
| ltm-DL-OrJointTCI-StateToReleaseList-r18 | SEQUENCE (SIZE |

(1..maxNrofCandidateTCI-States-r18)) OF CandidateTCI-StateId-r18
OPTIONAL, -- Need N

| | |
|---|---|
| ltm-UL-TCI-ToAddModList-r18 | SEQUENCE (SIZE |

(1..maxNrofCandidateUL-TCI-r18)) OF CandidateTCI-UL-State-r18
OPTIONAL, -- Need N

| | |
|---|---|
| ltm-UL-TCI-ToReleaseList-r18 | SEQUENCE (SIZE (1.. |

maxNrofCandidateUL-TCI-r18)) OF CandidateTCI-UL-StateId-r18
OPTIONAL, -- Need N

| | |
|---|---|
| ltm-UE-MeasuredTA-ID-r18 | INTEGER |
| (1..maxNrofCellsLTM-r18-1) | OPTIONAL, -- Need M |

...
}
LTM-SSB-Config-r18 ::= SEQUENCE {

| | |
|---|---|
| ssbFrequency-r18 | ARFCN-ValueNR, |
| subCarrierSpacing-r18 | SubCarrierSpacing, |
| ssb-Periodicity-r18 | ENUMERATED {ms5, |
| ms10, ms20, ms40, ms80, ms160, spare2, spare1} | OPTIONAL, -- Need R |
| ssb-PositionsInBurst-r18 | CHOICE { |
| shortBitmap | BIT STRING (SIZE |

(4)),

| | |
|---|---|
| mediumBitmap | BIT STRING (SIZE |

(8)),

| | |
|---|---|
| longBitmap | BIT STRING (SIZE |

(64))
}
OPTIONAL, -- Need R

| | |
|---|---|
| ss-PBCH-BlockPower-r18 | INTEGER (−60..50) |

OPTIONAL, -- Need R
...
}
-- TAG-LTM-CANDIDATETOADDMODLIST-STOP
-- ASN1STOP

According to Table 5 and Table 6, one RRCReconfiguration message may be configured for each candidate target configuration RRCReconfiguration to configure target candidate cells.

In NR-DC, the UE may receive two independent ltm-Config:
an ltm-Config associated with the MCG that is included within an RRCReconfiguration message received via SRB1; and
an ltm-Config associated with the SCG that is included within an RRCReconfiguration message either received via SRB3, or, alternatively, embedded in an RRCReconfiguration message received via SRB1.

In this case:
the UE maintains two independent VarLTM-Config, one associated with each ltm-Config;
the UE maintains two independent VarLTM-ServingCellNoResetID, one associated with each ltm-Config;
the UE maintains two independent VarLTM-ServingCellUE-MeasuredTA-ID, one associated with each ltm-Config;
the UE independently performs all the below procedures for each ltm-Config and the associated VarLTM-Config, unless explicitly stated otherwise.

The UE may perform the following actions based on the received LTM-Config IE:
1> if the received LTM-Config includes ltm-ReferenceConfiguration:
2> if the current VarLTM-Config includes an ltm-ReferenceConfiguration:
3> replace the ltm-ReferenceConfiguration value within VarLTM-Config with the received ltm-ReferenceConfiguration;
2> else:
3> store the received ltm-ReferenceConfiguration to VarLTM-Config;
1> if the received LTM-Config includes ltm-ServingCellNoResetID;
2> if the current VarLTM-ServingCellNoResetID includes an ltm-ServingCellNoResetID:
3> replace the ltm-ServingCellNoResetID value within VarLTM-ServingCellNoResetID with the received ltm-ServingCellNoResetID;
2> else:
3> store the received ltm-ServingCellNoResetID to VarLTM-ServingCellNoResetID;
1> if the received LTM-Config includes ltm-ServingCellUE-MeasuredTA-ID:
2> if the current VarLTM-ServingCellUE-MeasuredTA-ID includes an ltm-ServingCellUE-MeasuredTA-ID:
3> replace the ltm-ServingCellUE-MeasuredTA-ID value within VarLTM-ServingCellUE-MeasuredTA-ID with the received ltm-ServingCellUE-MeasuredTA-ID;
2> else:
3> store the received ltm-ServingCellUE-MeasuredTA-ID to VarLTM-ServingCellUE-MeasuredTA-ID;
1> if the received LTM-Config includes ltm-CSI-ResourceConfigToAddModList:
2> if the current VarLTM-Config includes an ltm-CSI-ResourceConfigToAddModList:
3> replace the ltm-CSI-ResourceConfigToAddModList value within VarLTM-Config with the received ltm-CSI-ResourceConfigToAddModList;
2> else:
3> store the received ltm-CSI-ResourceConfigToAddModList to VarLTM-Config;
1> else if the received LTM-Config includes the ltm-CandidateToAddModList:
2> perform the LTM candidate cell addition or reconfiguration.

For LTM candidate cell addition/modification, the UE may:
1> for each ltm-CandidateId value in the ltm-CandidateToAddModList:
2> if the current VarLTM-Config includes an LTM-Candidate with the given ltm-CandidateId value:
3> replace the LTM-Candidate within VarLTM-Config in accordance with the received LTM-Candidate;
2> else:
3> add the received LTM-Candidate to VarLTM-Config.

That is, in the RRC procedures, the candidate delta configuration may be applied on top of the reference configuration to form a complete candidate configuration when the UE receives the LTM configuration (before the LTM cell switch). In the RRC procedures, the complete candidate configuration may be applied and replacing the current UE configuration (at the time of reconfiguration execution/cell switch), by an RRC reconfiguration procedure that makes replacements of configuration but doesn't necessarily reset MAC, RLC or PDCP.

Upon the indication by lower layers that an LTM cell switch procedure is triggered, or upon performing LTM cell switch following cell selection performed while timer T311 was running, the UE may:
1> release/clear all current dedicated radio configuration associated with the cell group for which the LTM cell switch procedure is triggered except for the following:
2> if the LTM cell switch is triggered on the MCG:
   the MCG C-RNTI;
   the AS security configurations associated with the master key;
2> else, if the LTM cell switch is triggered on the SCG:
   the AS security configurations associated with the secondary key;
2> for each SRB/DRB in current UE configuration:
   keep the associated PDCP and SDAP entities, their state variables, buffers and timers;
   release all fields related to the SRB/DRB configuration except for srb-Identity and drb-Identity;
2> for each RLC bearer in current UE configuration of the cell group for which LTM is triggered:
   keep the associated RLC entity, its state variables, buffers, and timers;
   release all fields related to the RLC-BearerConfig except for logicalChannelIdentity and logicalChannelIdentityExt.
   the UE variables VarLTM-Config and VarLTM-ServingCellNoResetID.
1> release/clear all current common radio configuration associated with the cell group for which the LTM cell switch procedure is triggered;
1> use the default values for timers T310, T311 and constants N310, N311 associate to cell group for which the LTM cell switch procedure is triggered;
1> apply the default L1 parameter values as specified in corresponding physical layer specifications;
1> if the value of field ltm-NoResetID contained within the LTM-Candidate IE in VarLTM-Config indicated by lower layers or for the selected cell is equal to the value of ltm-ServingCellNoResetID within VarLTM-ServingCellNoResetID:
2> continue using the current RLC entity in the LTM candidate configuration indicated by lower layers;
2> replace the value of ltm-ServingCellNoResetID in VarLTM-ServingCellNoResetID with the value received within ltm-NoResetID;
1> else:
2> for each RLC-BearerConfig within rlc-BearerToAddModList that is part of current UE configuration:
3> re-establish the RLC entity;
2> for each drb-Identity value included in the drb-ToAddModList that is part of the current UE configuration:
3> trigger the PDCP entity of this DRB to perform data recovery;
2> replace the value of ltm-ServingCellNoResetID in VarLTM-ServingCellNoResetID with the value of ltm-NoResetID in the LTM-Candidate in VarLTM-Config indicated by lower layers or for the selected cell;
1> if the value of field ltm-UE-MeasuredTA-ID contained within the LTM-Candidate IE in VarLTM-Config indicated by lower layers or for the selected cell is equal to the value of ltm-ServingCellUE-MeasuredTA-ID within VarLTM-ServingCellUE-MeasuredTA-ID:
2> inform lower layers that UE should perform UE-based TA measurements;
2> replace the value of ltm-ServingCellUE-MeasuredTA-ID in VarLTM-ServingCellUE-MeasuredTA-ID with the value received within ltm-UE-MeasuredTA-ID;
1> else:
2> replace the value of ltm-ServingCellUE-MeasuredTA-ID in VarLTM-ServingCellUE-MeasuredTA-ID with the value of ltm-UE-MeasuredTA-ID in the LTM-Candidate in VarLTM-Config indicated by lower layers or for the selected cell;
1> continue using the current PDCP entity in the LTM candidate configuration indicated by lower layers; 1> if ltm-ConfigComplete is not included within the LTM-Candidate IE in VarLTM-Config indicated by lower layers or for the selected cell:
2> consider ltm-ReferenceConfiguration in VarLTM-Config to be the current UE configuration.
1> if the LTM cell switch is triggered by an indication from lower layers:
2> apply the LTM configuration in ltm-CandidateConfig within LTM-Candidate IE in VarLTM-Config related to the LTM candidate configuration identity as received from lower layers;
1> else (LTM cell switch triggered upon cell selection performed while timer T311 was running):
2> apply the LTM configuration in ltm-CandidateConfig within LTM-Candidate IE in VarLTM-Config related to the LTM candidate configuration identity corresponding to the cell selected while timer T311 was running;
2> perform LTM configuration release procedure for the MCG.

LTM may fail. When conventional mobility (e.g., handover) fails, the UE may perform/initiate RRC re-establishment procedure. If the UE initiates RRC re-establishment procedure due to LTM failure, it causes not only a large interruption but also unnecessary reconfiguration after the re-establishment.

For faster recovery, the UE may utilize configured candidate cells. For example, upon failure of LTM, the UE may attempt to access one of other candidate cells. In this case, if the UE arbitrarily selects a target cell from among the configured candidate cells, the UE may select a target cell that is not preferred by the network for recovery. For example, some candidate cells may not be fully prepared for fast recovery while other candidates may have been fully prepared for fast recovery. If the UE attempts to access a candidate cell that is not fully prepared for fast recovery, the recovery may be delayed and/or even fail.

According to implementations of the present disclosure, the pre-configured candidate cells for LTM may be classified into one or more primary candidate cells and one or more secondary candidate cells. Upon detecting a failure of LTM to a primary candidate cell from among the one or more primary candidate cells, the UE may attempt to access a secondary candidate cell from among the one or more secondary candidate cells.

According to implementations of the present disclosure, the network may indicate to the UE some of the pre-configured candidate cells for LTM. For example, the network may transmit indication/information informing the one or more secondary candidate cells to the UE.

According to implementations of the present disclosure, for signaling of the indication/information, the indication/information may be included in LTM command and/or cell switch command. The indication/information may be configured as part of a candidate cell configuration. The indication/information may be pre-configured as part of a serving cell configuration. That is, the indication/information may be pre-configured per serving cell. When multiple serving cells are configured, the indication/information may be provided in each of the serving cell configuration. The indication/information may be pre-configured per a pair of a target cell and a source cell. In this case, the source cell configuration may be preserved only if the mobility results in a change of a serving cell from the source cell to the target cell. The indication may be provided in conditional mobility configuration.

According to implementations of the present disclosure, the network may indicate priority information of each of the one or more secondary candidate cells. Then, upon detection of LTM failure, the UE may choose a secondary candidate cell with the highest priority from among the one or more secondary candidate cells and accesses the secondary candidate cell for recovery.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

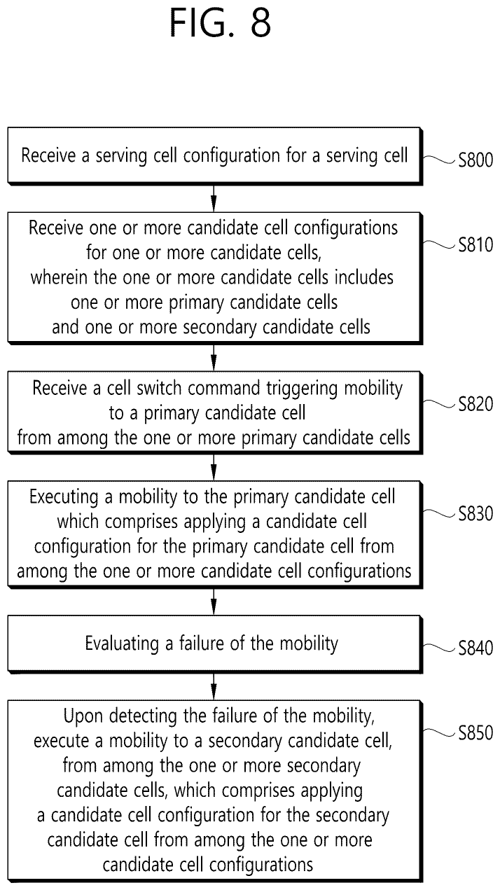

FIG. 8 shows an example of a method performed by a wireless device to which implementations of the present disclosure are applied.

In step S800, the method comprises receiving a serving cell configuration for a serving cell.

In step S810, the method comprises receiving one or more candidate cell configurations for one or more candidate cells. The one or more candidate cells includes one or more primary candidate cells and one or more secondary candidate cells

In step S820, the method comprises receiving a cell switch command triggering mobility to a primary candidate cell from among the one or more primary candidate cells.

In step S830, the method comprises executing a mobility to the primary candidate cell which comprises applying a candidate cell configuration for the primary candidate cell from among the one or more candidate cell configurations.

In step S840, the method comprises evaluating a failure of the mobility.

In step S850, the method comprises, upon detecting the failure of the mobility, executing a mobility to a secondary candidate cell, from among the one or more secondary candidate cells, which comprises applying a candidate cell configuration for the secondary candidate cell from among the one or more candidate cell configurations.

In some implementation, the method further comprises receiving information related to the one or more secondary candidate cells.

In some implementation, the information related to the one or more secondary candidate cells may be received via the one or more candidate cell configurations. In this case, the information related to the one or more secondary candidate cells may be included as a separate list from a list related to the one or more primary candidate cells. Or, the information related to the one or more secondary candidate cells may be included as a flag in a candidate cell configuration for each of the one or more primary candidate cells.

In some implementation, the information related to the one or more secondary candidate cells may be received via the cell switch command.

In some implementation, the information related to the one or more secondary candidate cells may include priority information for the one or more second candidate cells. In this case, the secondary candidate cell may have a highest priority from among the one or more secondary candidate cells based on the priority information.

In some implementation, the one or more secondary candidate cells may be a subset of the one or more primary candidate cells.

In some implementation, the one or more candidate cell configurations and/or the cell switch command may include information about a value of a timer for evaluating the failure of the mobility. In this case, evaluating the failure of the mobility may comprise starting the timer, and evaluating expiry of the timer based on the value of the timer. The timer may start upon transmitting an Uplink (UL) signal to the primary candidate cell for executing the mobility to the primary candidate cell. The timer may stop upon receiving from the primary candidate cell an acknowledgement of the UL signal transmitted to the primary candidate cell.

In some implementation, the wireless device may be in communication with at least one of a mobile device, a network, and/or autonomous vehicles other than the wireless device.

Furthermore, the method in perspective of the wireless device described above in FIG. 8 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 8.

More specifically, the wireless device receives a serving cell configuration for a serving cell.

The wireless device receives one or more candidate cell configurations for one or more candidate cells. The one or more candidate cells includes one or more primary candidate cells and one or more secondary candidate cells

The wireless device receives a cell switch command triggering mobility to a primary candidate cell from among the one or more primary candidate cells.

The wireless device executes a mobility to the primary candidate cell which comprises applying a candidate cell configuration for the primary candidate cell from among the one or more candidate cell configurations.

The wireless device evaluates a failure of the mobility.

Upon detecting the failure of the mobility, the wireless device executes a mobility to a secondary candidate cell, from among the one or more secondary candidate cells, which comprises applying a candidate cell configuration for the secondary candidate cell from among the one or more candidate cell configurations.

In some implementation, the wireless device may receive information related to the one or more secondary candidate cells.

In some implementation, the information related to the one or more secondary candidate cells may be received via the one or more candidate cell configurations. In this case, the information related to the one or more secondary candidate cells may be included as a separate list from a list related to the one or more primary candidate cells. Or, the information related to the one or more secondary candidate cells may be included as a flag in a candidate cell configuration for each of the one or more primary candidate cells.

In some implementation, the information related to the one or more secondary candidate cells may be received via the cell switch command.

In some implementation, the information related to the one or more secondary candidate cells may include priority information for the one or more second candidate cells. In this case, the secondary candidate cell may have a highest priority from among the one or more secondary candidate cells based on the priority information.

In some implementation, the one or more secondary candidate cells may be a subset of the one or more primary candidate cells.

In some implementation, the one or more candidate cell configurations and/or the cell switch command may include information about a value of a timer for evaluating the failure of the mobility. In this case, evaluating the failure of the mobility may comprise starting the timer, and evaluating expiry of the timer based on the value of the timer. The timer may start upon transmitting an Uplink (UL) signal to the primary candidate cell for executing the mobility to the primary candidate cell. The timer may stop upon receiving from the primary candidate cell an acknowledgement of the UL signal transmitted to the primary candidate cell.

Furthermore, the method in perspective of the wireless device described above in FIG. 8 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 8.

Furthermore, the method in perspective of the wireless device described above in FIG. 8 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 8.

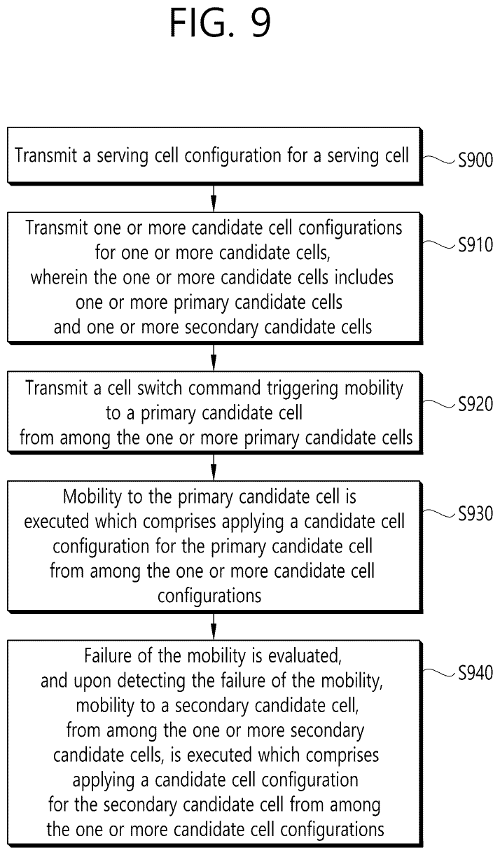

FIG. 9 shows an example of a method performed by a base station to which implementations of the present disclosure are applied.

In step S900, the method comprises transmitting a serving cell configuration for a serving cell

In step S910, the method comprises transmitting one or more candidate cell configurations for one or more candidate cells. The one or more candidate cells include one or more primary candidate cells and one or more secondary candidate cells.

In step S920, the method comprises transmitting a cell switch command triggering mobility to a primary candidate cell from among the one or more primary candidate cells.

In step S930, a mobility to the primary candidate cell is executed which comprises applying a candidate cell configuration for the primary candidate cell from among the one or more candidate cell configurations.

In step S940, failure of the mobility is evaluated, and upon detecting the failure of the mobility, mobility to a secondary candidate cell, from among the one or more secondary candidate cells, is executed which comprises applying a candidate cell configuration for the secondary candidate cell from among the one or more candidate cell configurations.

Furthermore, the method in perspective of the base station serving a second serving cell described above in FIG. 9 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 9.

More specifically, the base station transmits a serving cell configuration for a serving cell

The base station transmits one or more candidate cell configurations for one or more candidate cells. The one or more candidate cells include one or more primary candidate cells and one or more secondary candidate cells.

The base station transmits a cell switch command triggering mobility to a primary candidate cell from among the one or more primary candidate cells.

A mobility to the primary candidate cell is executed which comprises applying a candidate cell configuration for the primary candidate cell from among the one or more candidate cell configurations.

Failure of the mobility is evaluated, and upon detecting the failure of the mobility, mobility to a secondary candidate cell, from among the one or more secondary candidate cells, is executed which comprises applying a candidate cell configuration for the secondary candidate cell from among the one or more candidate cell configurations.

Hereinafter, various embodiments of the present disclosure are described in below.

### (1) Implementation 1

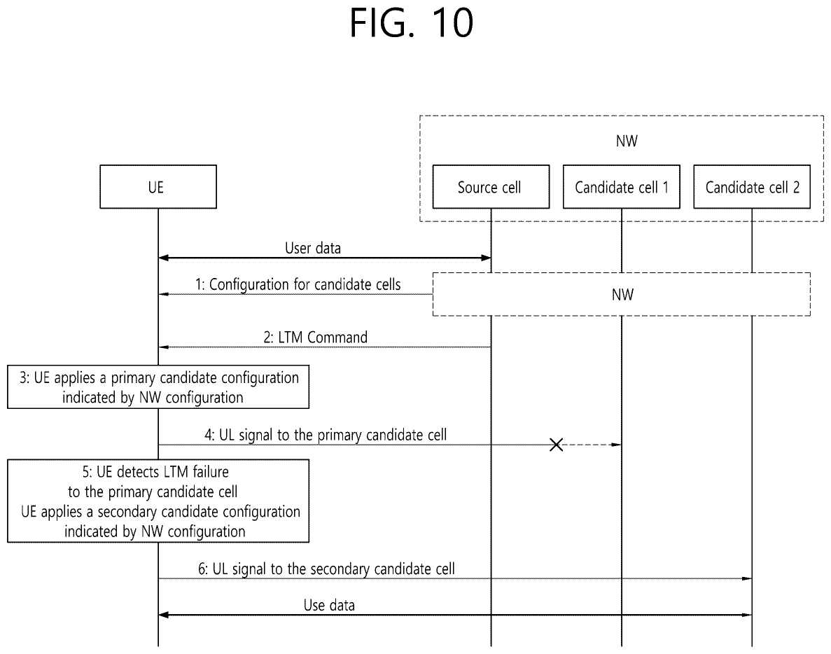

FIG. 10 shows an example of a procedure to which Implementation 1 of the present disclosure is applied.

According to Implementation 1 of the present disclosure, the indication/information is configured as part of a candidate cell configuration. UE operations according to Implementation 1 of the present disclosure may include at least one of steps described below.
(1) Step 1: The UE may receive one or more candidate cell configurations.

In the one or more candidate cell configurations, one or more candidate serving cells may also be configured.

The one or more candidate cell configurations may include at least one of the followings.
Configurations of a Special Cell (SpCell), e.g., servingCellConfigCommon, servingCellConfig, reconfigurationWithSync, Radio Link Failure (RLF) relevant configuration, etc.
Configurations of SCells, e.g., servingCellConfigCommon, servingCellConfig, smtc, Discontinuous Reception (DRX) configuration, etc.
MAC/RLC related configurations
List of one or more primary candidate cells
List of one or more secondary candidate cells
Configuration for detecting LTM failure: timer value for evaluating expiry.

The list of one or more secondary candidate cells may be included as a separate list from the list of one or more primary candidate cells.

The list of one or more secondary candidate cells may be subset of the list of one or more primary candidate cells.

Instead of the list of one or more secondary candidate cells, for each primary candidate cell from the one or more primary candidate cells, a flag may be included to indicate whether the corresponding cell can be a secondary candidate cell or not.
(2) Step 2: The UE receives an LTM command (i.e., cell switch command).

The LTM command may be received via one of L1/L2/L3 signaling.

The LTM command may be for either network controlled serving cell change (e.g., conventional mobility) or UE autonomous serving cell change (e.g., conditional mobility such as CHO, CPA, CPC)

The LTM command may include at least one of the followings.
Target cell information: If the target cell is one of the pre-configured candidate serving cells for the UE, the LTM command may include an identifier (ID) of candidate serving cell indicated by the LTM command. Else if the target cell is not one of the pre-configured candidate serving cells, the LTM command may include a configuration of the target cell, e.g., RRCReconfiguration including reconfigurationWithSync.
Conditional reconfiguration, e.g., ConditionalReconfiguration.
Indicator indicating that the source cell is changed to a candidate serving cell: For example, the indicator may be explicit 1-bit indication in DCI or MAC Control Element (CE). For example, the indicator may be explicit RRC Information Element (IE). For example, the LTM command received via L1/L2 signaling may implicitly indicate that the source cell is changed to a candidate serving cell. For example, the target cell may be included in the list, where the list may implicitly indicate that the source cell is changed to a candidate serving cell.
Configuration for detecting LTM failure: timer value for evaluating expiry.
(3) Step 3: The UE applies the candidate cell configuration of a primary candidate cell.

If the LTM command includes ConditionalReconfiguration and if an execution condition is satisfied for the primary candidate cell, the UE may apply the stored candidate cell configuration (e.g., condRRCReconfig) of the primary candidate cell that an execution condition is satisfied.

Else if the primary candidate cell is one of the pre-configured candidate serving cells for the UE, the UE may apply the stored candidate cell configuration of the primary candidate cell.

Else, the UE may apply the candidate cell configuration of the primary candidate cell which is included in the LTM command.
(4) Step 4: The UE executes the mobility to the primary candidate cell by transmitting an UL signal to the primary candidate cell.

The UE may transmit the UL signal to the primary candidate cell via at least one of L1 signaling, e.g., PUCCH, PUSCH, etc., L2 signaling, e.g., MAC CE, or L3 signaling, e.g., RRCReconfigurationComplete.

Upon transmitting the UL signal to the primary candidate cell, the UE may begin to evaluate mobility failures based on timer-based failure detection. For example, the timer may start upon transmitting the UL signal to the primary candidate cell. For example, the timer may stop upon receiving a message indicating an acknowledgement of the UL signal transmitted to the primary candidate cell. A value for the timer may be set for evaluating timer expiry.

The UE may receive a message indicating an acknowledgement of the UL signal transmitted to the primary candidate cell. Upon receiving the message, it may be considered the mobility to the primary candidate cell is successfully executed.

If the LTM command is received via one of L1/L2 signaling, the UE may keep the source resources and configurations and performs TA maintenance and Beam Failure Detection (BFD) and/or Radio Link Monitoring (RLM). Else if the LTM command includes the indicator indicating that the source cell is changed to a candidate serving cell, the UE may keep the source resources and configurations and performs TA maintenance and BFD/RLM. Else, the UE may release the source resources and configurations and stops DL/UL reception/transmission with the source cell.
(5) Step 5: If the UE detects a failure of LTM to the primary candidate cell, the UE applies the candidate cell configuration of a secondary candidate cell.

The failure may be detected upon expiry of the timer described in step 4.

If the LTM command includes ConditionalReconfiguration and if an execution condition is satisfied for the secondary candidate cell, the UE may apply the stored candidate cell configuration (e.g., condRRCReconfig) of the secondary candidate cell that an execution condition is satisfied.

Else if the secondary candidate cell is one of the pre-configured candidate serving cells for the UE, the UE may apply the stored candidate cell configuration of the secondary candidate cell.

Else, the UE may apply the candidate cell configuration of the secondary candidate cell which is included in the LTM command.

The UE may need to revert back to the previous source cell (group) configuration prior to the LTM and apply the candidate cell configuration of the secondary candidate cell possibly while taking the previous source cell (group) configuration and/or other reference cell configuration, if configured, as baseline.
(6) Step 6: The UE executes the mobility to the secondary candidate cell by transmitting an UL signal to the secondary candidate cell.

The UE may synchronize with the secondary candidate cell.

The UE may transmit the UL signal to the secondary candidate cell via at least one of L1 signaling, e.g., PUCCH, PUSCH, etc., L2 signaling, e.g., MAC CE, or L3 signaling, e.g., RRCReconfigurationComplete.

The UE may receive a message indicating an acknowledgement of the UL signal transmitted to the secondary candidate cell. Upon receiving the message, it may be considered the mobility to the secondary candidate cell is successfully executed.

If the LTM command is received via one of L1/L2 signaling, the UE may keep the source resources and configurations and performs TA maintenance and BFD/RLM. Else if the LTM command includes the indicator indicating that the source cell is changed to a candidate serving cell, the UE may keep the source resources and configurations and performs TA maintenance and BFD/RLM. Else, the UE may release the source resources and configurations and stops DL/UL reception/transmission with the source cell.

### (1) Implementation 2

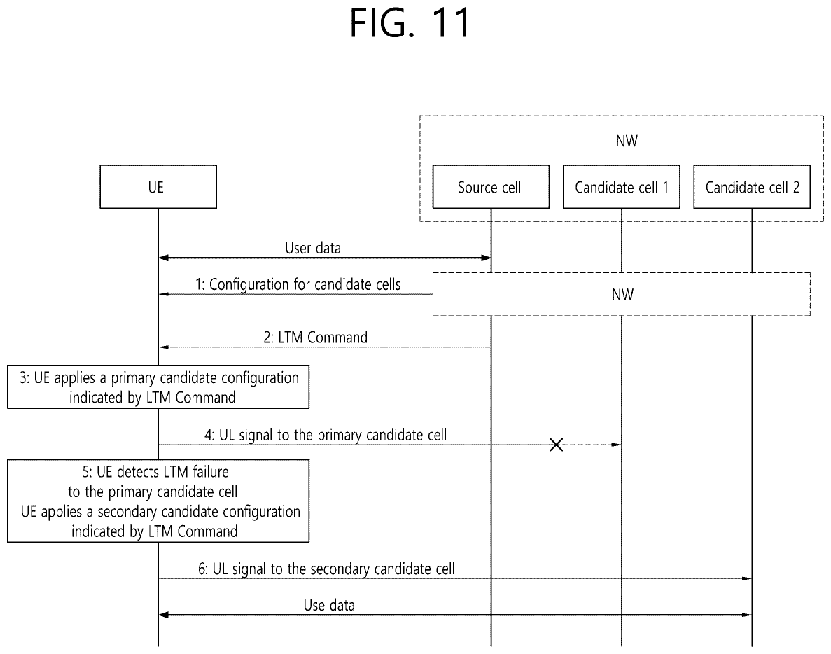

FIG. 11 shows an example of a procedure to which Implementation 2 of the present disclosure is applied.

According to Implementation 2 of the present disclosure, the indication/information is included in the LTM command. UE operations according to Implementation 2 of the present disclosure may include at least one of steps described below.
(1) Step 1: The UE may receive one or more candidate cell configurations.

In the one or more candidate cell configurations, one or more candidate serving cells may also be configured.

The one or more candidate cell configurations may include at least one of the followings.
Configurations of a SpCell, e.g., servingCellConfigCommon, servingCellConfig, reconfigurationWithSync, RLF relevant configuration, etc.
Configurations of SCells, e.g., servingCellConfigCommon, servingCellConfig, smtc, DRX configuration, etc.
MAC/RLC related configurations
Configuration for detecting LTM failure: timer value for evaluating expiry.

The list of one or more secondary candidate cells may be included as a separate list from the list of one or more primary candidate cells.

The list of one or more secondary candidate cells may be subset of the list of one or more primary candidate cells.

Instead of the list of one or more secondary candidate cells, for each primary candidate cell from the one or more primary candidate cells, a flag may be included to indicate whether the corresponding cell can be a secondary candidate cell or not.
(2) Step 2: The UE receives an LTM command (i.e., cell switch command).

The LTM command may be received via one of L1/L2/L3 signaling.

The LTM command may be for either network controlled serving cell change (e.g., conventional mobility) or UE autonomous serving cell change (e.g., conditional mobility such as CHO, CPA, CPC)

The LTM command may include at least one of the followings.
List of one or more primary candidate cells
List of one or more secondary candidate cells
Target cell information: If the target cell is one of the pre-configured candidate serving cells for the UE, the LTM command may include an ID of candidate serving cell indicated by the LTM command. Else if the target cell is not one of the pre-configured candidate serving cells, the LTM command may include a configuration of the target cell, e.g., RRCReconfiguration including reconfigurationWithSync.
Conditional reconfiguration, e.g., ConditionalReconfiguration.
Indicator indicating that the source cell is changed to a candidate serving cell: For example, the indicator may be explicit 1-bit indication in DCI or MAC CE. For example, the indicator may be explicit RRC IE. For example, the LTM command received via L1/L2 signaling may implicitly indicate that the source cell is changed to a candidate serving cell. For example, the target cell may be included in the list, where the list may implicitly indicate that the source cell is changed to a candidate serving cell.
Configuration for detecting LTM failure: timer value for evaluating expiry.
(3) Step 3: The UE applies the candidate cell configuration of a primary candidate cell.

If the LTM command includes ConditionalReconfiguration and if an execution condition is satisfied for the primary candidate cell, the UE may apply the stored candidate cell configuration (e.g., condRRCReconfig) of the primary candidate cell that an execution condition is satisfied.

Else if the primary candidate cell is one of the pre-configured candidate serving cells for the UE, the UE may apply the stored candidate cell configuration of the primary candidate cell.

Else, the UE may apply the candidate cell configuration of the primary candidate cell which is included in the LTM command.
(4) Step 4: The UE executes the mobility to the primary candidate cell by transmitting an UL signal to the primary candidate cell.

The UE may transmit the UL signal to the primary candidate cell via at least one of L1 signaling, e.g., PUCCH, PUSCH, etc., L2 signaling, e.g., MAC CE, or L3 signaling, e.g., RRCReconfigurationComplete.

Upon transmitting the UL signal to the primary candidate cell, the UE may begin to evaluate mobility failures based on timer-based failure detection. For example, the timer may start upon transmitting the UL signal to the primary candidate cell. For example, the timer may stop upon receiving a message indicating an acknowledgement of the UL signal transmitted to the primary candidate cell. A value for the timer may be set for evaluating timer expiry.

The UE may receive a message indicating an acknowledgement of the UL signal transmitted to the primary candidate cell. Upon receiving the message, it may be considered the mobility to the primary candidate cell is successfully executed.

If the LTM command is received via one of L1/L2 signaling, the UE may keep the source resources and configurations and performs TA maintenance and Beam Failure Detection (BFD) and/or Radio Link Monitoring (RLM). Else if the LTM command includes the indicator indicating that the source cell is changed to a candidate serving cell, the UE may keep the source resources and configurations and performs TA maintenance and BFD/RLM. Else, the UE may release the source resources and configurations and stops DL/UL reception/transmission with the source cell.
(5) Step 5: If the UE detects a failure of LTM to the primary candidate cell, the UE applies the candidate cell configuration of a secondary candidate cell.

The failure may be detected upon expiry of the timer described in step 4.

If the LTM command includes ConditionalReconfiguration and if an execution condition is satisfied for the secondary candidate cell, the UE may apply the stored candidate cell configuration (e.g., condRRCReconfig) of the secondary candidate cell that an execution condition is satisfied.

Else if the secondary candidate cell is one of the pre-configured candidate serving cells for the UE, the UE may apply the stored candidate cell configuration of the secondary candidate cell.

Else, the UE may apply the candidate cell configuration of the secondary candidate cell which is included in the LTM command.

The UE may need to revert back to the previous source cell (group) configuration prior to the LTM and apply the candidate cell configuration of the secondary candidate cell possibly while taking the previous source cell (group) configuration and/or other reference cell configuration, if configured, as baseline.
(6) Step 6: The UE executes the mobility to the secondary candidate cell by transmitting an UL signal to the secondary candidate cell.

The UE may synchronize with the secondary candidate cell.

The UE may transmit the UL signal to the secondary candidate cell via at least one of L1 signaling, e.g., PUCCH, PUSCH, etc., L2 signaling, e.g., MAC CE, or L3 signaling, e.g., RRCReconfigurationComplete.

The UE may receive a message indicating an acknowledgement of the UL signal transmitted to the secondary candidate cell. Upon receiving the message, it may be considered the mobility to the secondary candidate cell is successfully executed.

If the LTM command is received via one of L1/L2 signaling, the UE may keep the source resources and configurations and performs TA maintenance and BFD/RLM. Else if the LTM command includes the indicator indicating that the source cell is changed to a candidate serving cell, the UE may keep the source resources and configurations and performs TA maintenance and BFD/RLM. Else, the UE may release the source resources and configurations and stops DL/UL reception/transmission with the source cell.

The present disclosure may have various advantageous effects.

For example, a UE can attempt to access a secondary candidate cell upon detecting a failure of LTM to a primary candidate cell.

For example, user data interruption can be reduced by performing faster recovery than conventional failure recovery based on an RRC reestablishment procedure.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving a serving cell configuration for a serving cell;
receiving one or more candidate cell configurations for one or more candidate cells,
wherein the one or more candidate cells include one or more primary candidate cells and one or more secondary candidate cells;
receiving a cell switch command triggering mobility to a primary candidate cell from among the one or more primary candidate cells;
executing a mobility to the primary candidate cell which comprises applying a candidate cell configuration for the primary candidate cell from among the one or more candidate cell configurations;
evaluating a failure of the mobility; and
upon detecting the failure of the mobility, executing a mobility to a secondary candidate cell, from among the one or more secondary candidate cells, which comprises applying a candidate cell configuration for the secondary candidate cell from among the one or more candidate cell configurations.

2. The method of claim 1, wherein the method further comprises receiving information related to the one or more secondary candidate cells.

3. The method of claim 2, wherein the information related to the one or more secondary candidate cells is received via the one or more candidate cell configurations.

4. The method of claim 3, wherein the information related to the one or more secondary candidate cells is included as a separate list from a list related to the one or more primary candidate cells.

5. The method of claim 3, wherein the information related to the one or more secondary candidate cells is included as a flag in a candidate cell configuration for each of the one or more primary candidate cells.

6. The method of claim 2, wherein the information related to the one or more secondary candidate cells is received via the cell switch command.

7. The method of claim 2, wherein the information related to the one or more secondary candidate cells includes priority information for the one or more second candidate cells.

8. The method of claim 7, wherein the secondary candidate cell has a highest priority from among the one or more secondary candidate cells based on the priority information.

9. The method of claim 1, wherein the one or more secondary candidate cells are a subset of the one or more primary candidate cells.

10. The method of claim 1, wherein the one or more candidate cell configurations and/or the cell switch command includes information about a value of a timer for evaluating the failure of the mobility.

11. The method of claim 10, wherein evaluating the failure of the mobility comprises:
starting the timer; and
evaluating expiry of the timer based on the value of the timer.

12. The method of claim 11, wherein the timer starts upon transmitting an Uplink (UL) signal to the primary candidate cell for executing the mobility to the primary candidate cell.

13. The method of claim 11, wherein the timer stops upon receiving from the primary candidate cell an acknowledgement of the UL signal transmitted to the primary candidate cell.

14. The method of claim 1, wherein the method is performed by a wireless device, and
wherein the wireless device is in communication with at least one of a mobile device, a network, and/or autonomous vehicles other than the wireless device.

15. A wireless device comprising:
at least one transceiver;
at least one processor; and
at least one memory operably connectable to the at least one processor and storing instructions that, based on being executed by the at least one processor, perform operations comprising:
receiving, via the at least one transceiver, a serving cell configuration for a serving cell;
receiving, via the at least one transceiver, one or more candidate cell configurations for one or more candidate cells,
wherein the one or more candidate cells include one or more primary candidate cells and one or more secondary candidate cells;
receiving, via the at least one transceiver, a cell switch command triggering mobility to a primary candidate cell from among the one or more primary candidate cells;
executing a mobility to the primary candidate cell which comprises applying a candidate cell configuration for the primary candidate cell from among the one or more candidate cell configurations;
evaluating a failure of the mobility; and
upon detecting the failure of the mobility, executing a mobility to a secondary candidate cell, from among the one or more secondary candidate cells, which comprises applying a candidate cell configuration for the secondary candidate cell from among the one or more candidate cell configurations.

16-18. (canceled)

19. A base station comprising:
at least one transceiver;
at least one processor; and
at least one memory operably connectable to the at least one processor and storing instructions that, based on being executed by the at least one processor, perform operations comprising:
transmitting, via the at least one transceiver, a serving cell configuration for a serving cell transmitting, via the at least one transceiver, one or more candidate cell configurations for one or more candidate cells,
wherein the one or more candidate cells include one or more primary candidate cells and one or more secondary candidate cells; and
transmitting, via the at least one transceiver, a cell switch command triggering mobility to a primary candidate cell from among the one or more primary candidate cells,
wherein a mobility to the primary candidate cell is executed which comprises applying a candidate cell configuration for the primary candidate cell from among the one or more candidate cell configurations, and
wherein a failure of the mobility is evaluated, and upon detecting the failure of the mobility, a mobility to a secondary candidate cell, from among the one or more secondary candidate cells, is executed which comprises applying a candidate cell configuration for the secondary candidate cell from among the one or more candidate cell configurations.
